(19) United States
(12) Patent Application Publication
(10) Pub. No.: US 2008/0098011 A1
(43) Pub. Date: Apr. 24, 2008

(54) Method, Server, Software, Device, Signal Providing Configuration

(75) Inventors: Maarten Peter Bodlaender, Eindhoven (NL); Alexander Wilhelmus Heerink, Eindhoven (NL); Jarno Guidi, Bologna (IT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,811

(22) PCT Filed: Nov. 14, 2005
(86) PCT No.: PCT/IB05/53735

§ 371 Date: May 8, 2007

(30) Foreign Application Priority Data
Nov. 16, 2004 (EP) 04105796.9

(51) Int. Cl. G06F 15/177; G06F 17/30

(52) U.S. Cl. 707/100; 709/220; 707/E17.044

(57) ABSTRACT

An illumination system has a plurality of light-emitting diodes (R, G, B), at least one light-collimating section (12, 12′) arranged along a longitudinal axis (25) of the illumination system. The light-collimating sections merges into a light-mixing section (3) having a plurality of side-faces along the longitudinal axis (25). Light propagation in the light-mixing section is based on total internal reflection. The light-mixing section is provided with a light-exit window (13) emitting light towards an imaginary projection surface normal to the longitudinal axis. An end-portion (5) of the light-mixing section is provided with a prismatic protrusion portion (7) for obtaining a light distribution at the imaginary projection surface such that illumination at a first part of the imaginary projection surface is relatively low while illumination at a second part of the imaginary projection surface is relatively high, the first part being obtained at the same side of the longitudinal axis as the prismatic protrusion portion of the light-mixing section.

The present invention generally relates to the field of computer networks and more particularly to a method, server, computer program product and signal for providing information about the configuration of devices in a network, a method device and computer program product for receiving information about the configuration of devices in a network as well as to a network of devices.

In the field of peer-to-peer networking the connectivity standard used is often the UPnP™ standard. This standard defines entities such as UPnP™ control points and UPnP™ devices. A UPnP™ device is here a logical entity that has a set of services it offers to different elements of the network and a UPnP™ control point is a logical entity that tries to get access to a UPnP™ device. A physical device can contain any number of UPnP™ devices and UPnP™ control points.

Before being able to use UPnP™ devices and services, a UPnP™ control point has to find out what UPnP devices and services are available in a network. UPnP™ control points can search for UPnP™ devices and services by sending out a multicast search request with a specific query. UPnP™ devices in the network respond to that search if their capabilities match the query. Typically one UPnP™ control point sends out such a search and gets a response from all the UPnP™ devices in the network. After that the UPnP™ control point can periodically recheck and/or automatically be notified of newly arrived devices and/or services or changes to existing devices and services. If a UPnP™ control point sends several such search requests a lot of the bandwidth is occupied by these requests. This situation may occur often if the UPnP™ control point is provided in a physical device, which gets connected and disconnected repeatedly to a wireless network.

One way of limiting the amount of traffic is by the provision of a directory server. This directory server then keeps track of all the UPnP™ devices in the network and the services and capabilities they provide. A UPnP™ control point that gets connected to the network will then only have to send out a query directed to this directory server, which responds with one listing of all the UPnP™ devices and their capabilities. This has the advantage that the number of search requests that is sent to all other UPnP™ devices is reduced. However if physical devices get connected and disconnected from the network repeatedly there is still a lot of traffic in the network, which it would be advantageous to limit.

Document US20010039588 describes a server that has a directory where the history of changes/states of a device is maintained together with timestamps. Past states of the device can be queried based on these time stamps. A client device therefore has to monitor the directory for changes in order to find out if it has changed state or not.

Hence there is a need for an improved network configuration updating scheme and in particular one that limits the amount of traffic when devices get connected/disconnected often.

It is an object of the present invention to provide an improved network configuration updating scheme.

According to a first aspect of the present invention, this object is achieved by a method of providing information about the configuration of devices in a network comprising the steps of:
receiving a first query about the configuration of at least a part of the network from a client device,
responding to the first query with at least partial information about the configuration of said part of the network existing at the time of reception of the first query, receiving a second query about the configuration of said part of the network from said client device,
determining the difference in configuration between said part of the network existing at the time of reception of the first query and at the time of reception of the second query, and
responding to the second query with information about said difference in configuration.

According to a second aspect of the present invention, this object is also achieved by a server for providing information about the configuration of devices in a network and arranged to:
receive a first query about the configuration of at least a part of the network from a client device,
respond to the first query with at least partial information about the configuration of said part of the network existing at the time of reception of the first query,
receive a second query about the configuration of said part of the network from said client device,
determine the difference in configuration between said part of the network existing at the time of reception of the first query and at the time of reception of the second query, and
respond to the second query with information about said difference in configuration.

According to a third aspect of the present invention, this object is also achieved by a computer program product for providing information about the configuration of devices in a network, comprising computer program code, to make a computer execute, when said program code is loaded in the computer:
receive a first query about the configuration of at least a part of the network from a client device,
respond to the first query with at least partial information about the configuration of said part of the network existing at the time of reception of the first query,
receive a second query about the configuration of said part of the network from said client device,
determine the difference in configuration between said part of the network existing at the time of reception of the first query and at the time of reception of the second query, and
respond to the second query with information about said difference in configuration.

According to a fourth aspect of the present invention, the object is also achieved by a method of receiving information about the configuration of devices in a network, comprising the steps of:
sending a first query about the configuration of at least a part of the network to a server,
receiving a response to the first query with at least partial information about the configuration of said part of the network existing at the time the server received the first query,
sending a second query about the configuration of said part of the network to said server, and
receiving a response to the second query with information about the difference in configuration between said part of the network existing at the time the server received the first query and at the time the server received the second query.

According to a fifth aspect of the present invention, the object is also achieved by a client device for receiving information about the configuration of devices in a network and arranged to:
send a first query about the configuration of at least a part of the network to a server,
receive a response to the first query with at least partial information about the configuration of said part of the network existing at the time the server received the first query,
send a second query about the configuration of said part of the network to said server, and
receive a response to the second query with information about the difference in configuration between said part of the network existing at the time the server received the first query and at the time the server received the second query.

According to a sixth aspect of the present invention, this object is also achieved by a computer program product for receiving information about the configuration of devices in a network, comprising computer program code, to make a computer execute, when said program code is loaded in the computer:
send a first query about the configuration of at least a part of the network to a server,
receive a response to the first query with at least partial information about the configuration of said part of the network existing at the time the server received the first query,
send a second query about the configuration of said part of the network to said server, and
receive a response to the second query with information about the difference in configuration between said part of the network existing at the time the server received the first query and at the time the server received the second query.

According to a seventh aspect of the present invention, this object is also achieved by a network of computing devices comprising:
a server for providing information about the configuration of devices in the network and arranged to:
receive a first query about the configuration of at least a part of the network from a client device,
respond to the first query with at least partial information about the configuration of said part of the network existing at the time of reception of the first query,
receive a second query about the configuration of said part of the network from said client device,
determine the difference in configuration between said part of the network existing at the time of reception of the first query and at the time of reception of the second query, and
respond to the second query with information about said difference in configuration, and
a client device for receiving information about the configuration of devices in the network and arranged to:
   send said first query,
   receive said response to the first query,
   send said second query, and
   receive said response to the second query.

According to an eight aspect of the present invention, this object is furthermore achieved by a signal for providing information about the configuration of devices in a network and comprising:
information about the difference in configuration between at least a part of the network existing at the time a server received a first query and at the time said server received a second query, where the signal is a response to said second query.

The present invention has the advantage of providing an enhanced network configuration updating scheme. Because only the difference of the network configuration is sent as a response to a network configuration query, the amount of information sent in the network can be significantly reduced. This reduction gets more important the more devices that are provided in a network, the fewer the changes are to the network and the more often a client device needing such configuration information gets disconnected and reconnected. Some changes of the network configuration can furthermore be made because a device leaves and enters a network. Such changes can undo previous changes and therefore the same network configuration may occur several times. This means that even if many changes are made to the network, a client device might not need much additional network configuration information.

According to one optional feature of the present invention, the response to the first query comprises information about the whole configuration of said part of the network in case no query had been sent from the client device before said first query.

Claims 2 and 12 are directed towards the generation and use of a configuration indicator. By using a configuration indicator, it is easy to keep track of different configurations, limit the size of queries and responses as well as allow the comparison of configurations faster.

According to claim 3 the difference of configuration is set to zero if two compared configuration indicators are equal. This measure allows a direct response virtually occupying no bandwidth if there is no difference in network configuration to be informed to a device.

According to claim 5 a configuration indicator is related to the whole network, this has the advantage of providing a simple way of providing configuration change information.

Claims 6 and 7 are directed towards configuration indicators that provide differentiated information for different parts of the network. This has the advantage of enabling provision of configuration information in relation only to the parts of a network that a device is interested in, which can further reduce the amount of information transmitted.

According to an optional feature of the present invention the response to the second query comprises also the second configuration indicator. This feature has the advantage of allowing later queries to be responded to with limited configuration information.

Claims 8 and 13 are directed towards using configuration change indicators. This has the advantage of allowing easier bookkeeping of all configuration changes in the network including changes that undo earlier changes. This information might be of interest for some applications.

According to further optional features of the present invention a configuration change indicator may also be provided for the whole network. Such an indicator may furthermore be provided with more than one field, where each field is related to a certain part of the network. It is also possible to provide different configuration change indicators, where one configuration change indicator is related to a certain part of the network.

According to claim 14, a client device may use also the configuration change indicator in order to find out different configuration changes. This is advantageous since this information is not present for a client device in case the configuration difference does not reflect a change of configuration.

According to claim 15, earlier received configuration information is updated with said information about the difference in configuration. This has the advantage of using previous configuration knowledge in order to reduce the amount information received as response to further queries.

The expression “change of configuration of a network” is intended to comprise any change that is made to the network in question, like the adding/removal of devices as well as the change of state of devices.

The expression “part of a network” is intended to comprise that a network has been divided in parts according to device types, where devices of a certain type are provided on one part of the network.

The general idea behind the invention is thus to only update a device about the configuration of a network with information that it does not previously have. This allows the reduction of the amount of information provided in responses to network configuration queries.

These and other aspects of the invention will be apparent from and elucidated with reference to the embodiments described hereinafter.

The present invention will now be explained in more detail in relation to the enclosed drawings, where

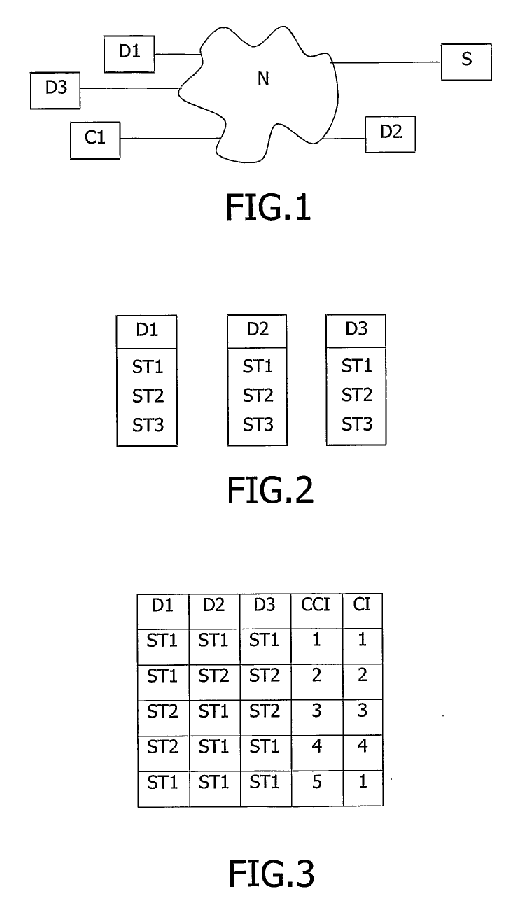

FIG. 1 shows a block schematic of a number of devices connected to a network comprising a directory server,

FIG. 2 shows a number of state tables showing different states that devices in the network can have,

FIG. 3 shows a table mapping different network configurations to corresponding configuration change indicators and configuration indicators,

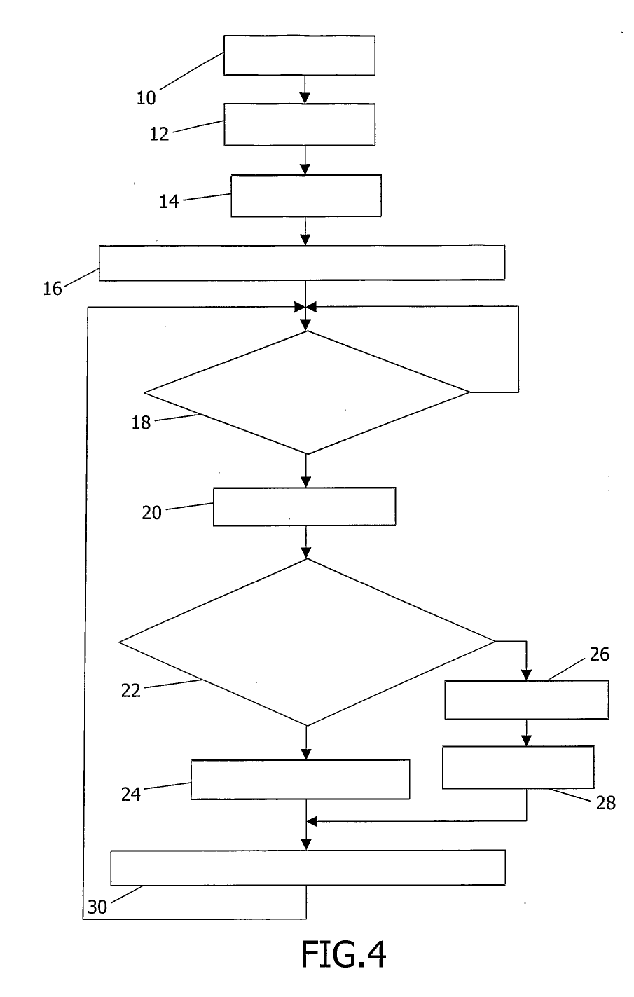

FIG. 4 shows a flow chart of a method of keeping track of configuration changes in the server,

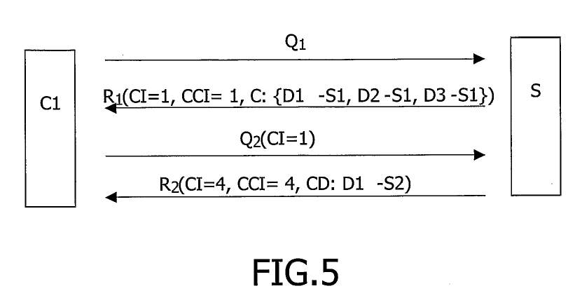

FIG. 5 schematically shows signals exchanged between a client device and the server in the network,

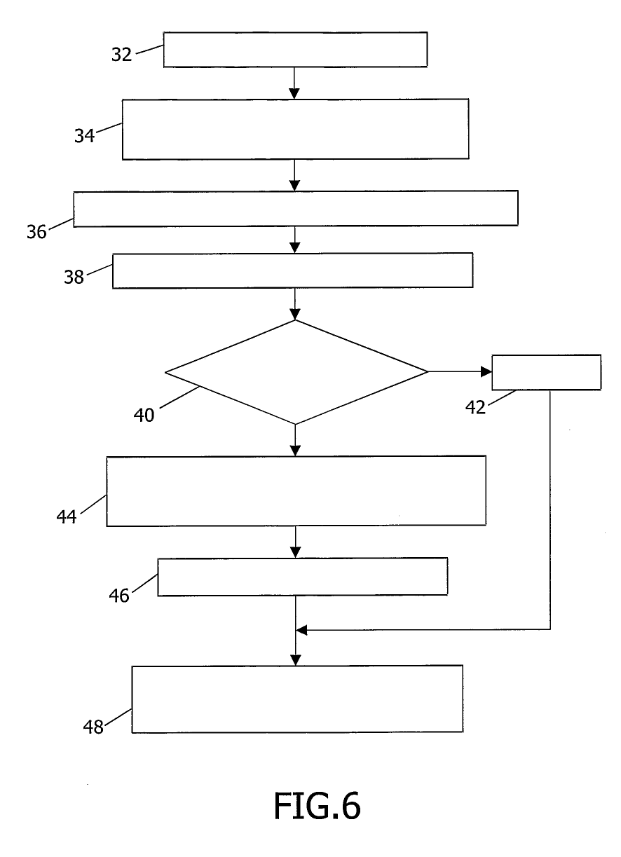

FIG. 6 shows a flow chart of a method of providing information about the configuration of devices in the network performed in the server,

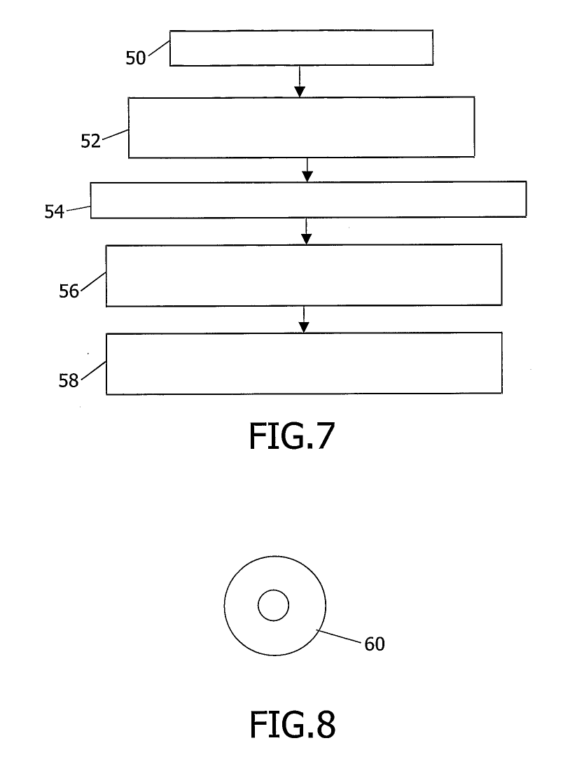

FIG. 7 shows a flow chart of a method of receiving information about the configuration of devices in the network performed in a client device, and

FIG. 8 shows a computer program product in the form of a CD ROM disc for storing of program code for performing the invention.

FIG. 1 shows a block schematic of a computer network N, where the invention may be implemented. The network N is in one embodiment a home network allowing peer-to-peer networking, in which different services can be provided. Because of this the network N includes a number of physical entities S, D1, D2, D3 and C1 of which one is a directory server S and some others are devices D1, D2, D3 that the server keeps track of. These physical devices D1, D2 and D3 include logical UPnP™ devices that provide different services like for instance MP3 player, web radio, DVD player etc. They can however also be other types of UPnP™ devices like an internet gateway or a printer. In order to better understand the invention, each physical device D1, D2, and D3 will in the following description be providing one logical UPnP™ device. There will therefore in the following description be no distinction made between a physical device and a logical UPnP™ device. It should however be realised that one such physical device can support more UPnP™ devices. At least one of the entities is furthermore a client device C1 via which a user can get access to the other devices in the network N. It should furthermore be realised that also the server S could provide functionalities of different types. The network is also preferably a wireless network, like for instance a wireless LAN network or a Bluetooth™ network, but is not limited to this and can also be a fixed network like a LAN network as well as a mixture with a wireless and a wired part. The peer-to-peer networking is here enabled by the UPnP™standard but other ways of connecting are just as well applicable like SLP (Service Location Protocol) or Jini.

The client device C1, will in the following description be assumed to comprise a UPnP™ control point, which accesses the services of UPnp™ devices provided by devices D1, D2 and D3. It should however be realised that a UPnP™ control point can also be provided in some other device that the client device can contact and then also in physical devices that provide UPnP™ devices. For the sake of easier understanding of the present invention, the control point is thus in the following assumed to be provided in a client device and will therefore not be explained further. Also the directory server will for the sake of easier understanding of the invention in the following be limited to keeping track of configuration changes and provide network configuration information.

In order to find out what devices and capabilities there exist in the network a client device, like for instance device C1, sends a query directed towards the directory server S. The query is here provided as a SOAP (Simple Object Action Protocol) action sent to the directory server S, which responds to such queries by indicating the devices that are present in the network and the states these devices have and thus the configuration of the network. This can be seen as the directory server being configured as a UPnP™ device that provides a service, the service of network configuration information, which the client device can access via a SOAP action. This also means that the client device C1 might send out an M-search in order to initially discover the presence of the directory server S. The directory server S thus keeps track of all the devices D1, D2 and D3 and their status and as a response to such a query the directory server S returns this information.

More details about UPnP™ control points, UPnP™ devices as well as SOAP actions can be found in the document UPnp™ Device Architecture, Version 1.0, 8 Jun. 2000, by UPnP Forum, which is herein incorporated by reference. One type of directory server is furthermore described in RFC2608, “Service Location Protocol, Version 2”, by E. Guttman, C. Perkins, J. Veizades and M. Day, Network Working Group, The Internet Society, June 1999, which is herein incorporated by reference.

However in wireless networks, devices can get moved, turned off, change status and thus change appearance from time to time. The reason for this can be several. If the device is battery powered it might be in a power save mode. The wireless link might be poor and thus the device might at times loose connectivity. The device might furthermore leave the network from time to time. It is also possible that new devices are connected to such a network. The configuration of the network can thus change from time to time. A client device can also get disconnected several times and it would typically make a new query every time it reconnects to the network. Each time it gets reconnected it would then get all the configuration information anew from the directory server. This means that there is a lot of overhead or extra data transmitted in the network in relation to such queries, which might take away useful bandwidth that could otherwise be used for more important information like the transmission of multimedia data. It would therefore be advantageous if this additional data or search overhead was reduced.

FIG. 2 shows a number of tables showing different states of the devices D1, D2, D3 in the network. From these tables it can be seen that the devices D1, D2 and D3 each have three different states ST1, ST2 and ST3. A state may represent that the device is disconnected or not present or if it is present or connected to have a certain active state. An example of this is if the device is a printer it may be able to provide colour printing or only black and white printing depending on if it is filled with ink or not. Needless to say there can be a number of different states for a device depending on the type of service it renders. However only three are shown here for the sake of simplicity and easier understanding of the invention. A state may also indicate how many of the services that a device normally provides, are available to other devices at a specific point in time.

FIG. 3 shows a table kept by the directory server, linking the states of the devices D1, D2 and D3 at a certain point in time to a configuration change indicator CCI in the form of a configuration change number and a configuration indicator CI in the form of a configuration number. Each row therefore shows a configuration of the network at a certain point in time. How this table is created and kept by the directory server will now be described also with reference being made to FIG. 4, which shows a flow chart of a method of keeping track of configuration changes.

When the network N is first put into operation the directory server S receives or gets information of all the devices D1, D2, D3 and their status. The network configuration or set of device statuses then gets associated with a configuration change indicator value CCI=1, step 10. At the same time a configuration counter CC is set to one, step 12. The configuration indicator CI is then set to one, step 14. This leads to the configuration indicator CI also being associated with the network configuration. As the table of FIG. 3 indicates the devices D1, D2 and D3 here all have state ST1, which is shown in row no. 2 of the table in FIG. 3. Thereafter the directory server S stores the configuration indicator CI together with the corresponding configuration information, i.e. information about all the states of the devices in the network as well as the configuration change indicator CCI, step 16. The directory server S then checks if the configuration is changed, step 18, i.e. if the state is changed for any of the devices in the network or if any new devices are added. If the configuration is unchanged, the server keeps on waiting. However if the configuration of the network is changed, step 18, like for instance if the status of one of the devices is changed, either through it being removed/disconnected or its working status being changed or a new device being connected to the network, the configuration change indicator CCI is incremented, step 20. Thereafter it is investigated if a previous CI setting exists for this configuration of the devices of the network, step 22. If this is not the case, the configuration counter CC is increased by one, step 26, followed by setting of the configuration indicator CI equal to the configuration counter CC, step 28. If there already is a previous configuration indicator CI set for this particular configuration, step 22, the current configuration indictor CI receives the same value that the configuration indicator of this earlier configuration has, step 24. Thereafter the configuration change indicator CCI, the configuration indicator CI and the configuration information are stored, step 30. Then the method continues with steps 18-30 as long as the directory server is connected to the network. The memory area of the directory server might be limited, so that only the most recent configurations, like for instance the last fifty configurations are stored and older configurations are removed from the directory server.

From the example shown in the table in FIG. 3 it can be seen that after the initial setting of the indicators, the second and third devices D2 and D3 change state to state ST2, which in this example is meant to indicate that devices D2 and D3 are no longer connected to the network. That particular state configuration has not previously been encountered in the network and therefore both the indicators CI and CCI are increased by one to the value of two. In the following state change, the first device D1 changes to state ST2, the second device D2 returns to state ST1 and the third device D3 retains state ST2. Also this network configuration is new and therefore both the indicators CI and CCI are incremented by one so that now they have the value of three. Thereafter the first device D1 retains state ST2, the second device D2 retains state ST1 and the third device D3 returns to state ST1, which now indicates that the third device is yet again connected to the network. As also this network configuration is new, both above-mentioned indicators are incremented yet again so that now they have the value of four. Finally also the first device D1 returns to state ST1, while the second and third devices D2 and D3 remain in state ST1. This is the network configuration that occurred originally, such that the configuration indicator CI receives the same value as the first configuration indicator, i.e. a value of one. The configuration change indicator CCI is incremented however and now has a value of five. If thereafter a new configuration is existing for the network, the configuration indicator would get the next higher value, i.e. five and the configuration change indicator the value six. In this way it is possible to keep track of changes made in the configuration of the network.

The different method steps of FIG. 4 are outlined in table 1 below.

TABLE 1

| | |
|---|---|
| 10 | CCI = 1 |
| 12 | CC = 1 |
| 14 | CI = CC |
| 16 | STORE CCI, CI AND CONFIGURATION |
| | INFO |
| 18 | CONFIGURATION CHANGE? |
| 20 | CCI = CCI + 1 |
| 22 | SAME CONFIGURATION AS FOR EARLIER |
| | CI? |
| 24 | CI = EARLIER CI |
| 26 | CC = CC + 1 |
| 28 | CI = CC |
| 30 | STORE CCI, CI AND CONFIGURATION |
| | INFO |

Once the directory sever has created these indicators it is now a simple task for a client device to make enhanced searches according to the invention and receive results that limit the search overhead.

How the server will update a client device on the network configuration upon receiving searches will now be described with reference being made to FIGS. 5 and 6, where the former figure schematically shows the signals exchanged between a client device and the server and the latter shows a flow chart of a method of providing information about the configuration of devices in a network according to the present invention.

The first time the client device C1 gets connected to the network N it performs a search in normal fashion. It sends a query Q₁ about the configuration of the network to the server S. The directory server S thus receives the query Q₁, step 32, and provides a response R₁ to the query Q₁ where it lists the devices and their states at the time the server received this first query, i.e., the network configuration. The information indicating the network configuration here thus sets out that the devices D1, D2 and D3 all have state ST1. In the response R₁ there is also provided a first change configuration indicator CCI=1 and a first configuration indicator CI=1 associated with the configuration information described above. After that the client device C1 gets disconnected and does not get connected again until the configuration change counter CCI has the value of four. At that time the client device D3 sends another search or a second query Q₂ about the network configuration. The second query Q₂ here includes the first configuration indicator CI it received in the first query, i.e. CI=1. The directory server S then receives the query Q₂, step 36, and goes on and compares the first CI with a second CI, which second CI is associated with the configuration at the time the server received this second query Q₂, step 38. If now the second CI is identical with the first CI, i.e. has a value of 1 according to the present example, configuration change data CD is set to zero, step 42, indicating that no configuration change has been made. If however the first CI differs from the second CI, step 40, the configuration of the network associated with the first CI is compared with the configuration of the network associated with the second CI, step 44. This is done by the server looking at the stored previous configurations for finding one having the same value as the first CI and comparing it with the configuration that is at hand at the moment. Configuration change data CD is then set as the difference in configuration, step 46. Since the configuration associated with the configuration indicator to indicate one is in this example compared with the configuration associated with the configuration indicator value four, the difference is that D1 now has state ST2. CD is thus set to indicate this state ST2 of device D1. Thereafter the server sends a response R₂ to the second query Q₂, step 48, where the response includes a second CI and second CCI associated with the present configuration of the network as well as the configuration difference data CD. If the second query was instead sent at the time the network had the last configuration shown in the table of FIG. 3, the CI values would have been identical and a CD set to zero had been sent instead.

The method steps of the directory server are outlined in table II below.

TABLE II

| | |
|---|---|
| 32 | RECEIVE FIRST QUERY |
| 34 | SEND FIRST CI, FIRST CCI AND FIRST |
| | CONFIGURATION INFO |
| 36 | RECEIVE SECOND QUERY INCLUDING FIRST CI |
| 38 | COMPARE FIRST CI WITH SECOND CI |
| 40 | FIRST CI = SECOND CI? |
| 42 | CD = 0 |
| 44 | COMPARE CONFIGURATION OF FIRST CI WITH |
| | CONFIGURATION OF SECOND CI |
| 46 | SET CD AS DIFFERENCE |
| 48 | SEND RESPONSE COMPRISING SECOND CCI, SECOND |
| | CI AND CD |

The operating of the client device C1 will now be described with reference being made to FIG. 6, which shows a flow chart of a method of receiving information about the configuration of the devices of a network according to the present invention. The client C1 thus first sends the first query Q1, step 50, and receives the response R₁ to this first query, step 52, where the response includes a first configuration change indicator CCI and a first configuration indicator CI and configuration information about the network from the time the server received the first query Q₁. The configuration information and the indicators CI and CCI are then stored for later use in the client device C1. The client device C1 then may get disconnected and upon later reconnection to the network it retrieves the stored first configuration indicator CI and then sends the second query Q₂ that includes the first configuration indicator CI, step 54. It then receives the response R₂ from the directory server, step 56, which response includes a second or current configuration indicator CI and a second or current configuration change indicator CCI, both associated with the network configuration from the time of reception of the second query by the server, as well as the configuration change data CD. Based on this response it then updates the configuration information stored, step 58. It thus adds the information CD to the previously stored configuration information in order to be able to correctly use the devices of the network. If the CD value was zero then the updating means that no change of the stored configuration information is made.

The client device C1 may be interested in the changes that have been made to the network between the queries, especially if the configuration change data CD was zero. In this case it may send further queries based on the CCI indicators to obtain the changes that were made to the network.

By receiving the second configuration indicator CI and second configuration change indicator CCI in the second response R₂ it is possible for the client device C1 to continue making simplified searches according to the invention and only get updated on the configuration differences. Thus each time a new query is sent, the response comprises partial information about the configuration the network has.

The method steps of the flow chart in FIG. 6 are outlined in table III below.

TABLE III

| | |
|---|---|
| 50 | SEND FIRST QUERY |
| 52 | RECEIVE FIRST CI, FIRST CCI AND FIRST CONFIGURATION |
| | INFO |
| 54 | SEND SECOND QUERY COMPRISING FIRST CI |
| 56 | RECEIVE SECOND RESPONSE COMPRISING SECOND CI, |
| | SECOND CCI AND CD |
| 58 | UPDATE FIRST CONFIGURATION INFO WITH CD |

The present invention thus provides an enhanced network configuration updating scheme where previous knowledge about the network is used. Because only updates of the network configuration are sent when a client device performs a new search, the search overhead is significantly reduced. This reduction gets more important the more devices that are provided in a network. If there are small changes of the network for a client device that gets disconnected and reconnected several times, the reduction of search overhead is significant.

There are several variations that can be made to the present invention. If a client device is a pure client and does not provide any service to other devices, it is possible to omit information about this device from the network configuration information. In the embodiment described above there was one configuration change indicator and configuration indicator provided for the whole network. This is advantageous in that the indicators are kept simple and easy to handle. The sizes of at least the queries and possibly also of the responses are also kept small. It is however possible that a device is only interested in configuration changes of a part of the network, like for instance only in devices of one type. In this case it is possible to provide information to the client device so that it can find out what parts are of interest. One way of doing this can be through the configuration indicator and possibly also the configuration change indicator being provided in the form of tuples, so that different fields of the indicator are directed towards different parts of the network, where one part of the network is typically made up of devices of the same type. A client device can then easily specify that only one specific field is of interest or only investigate that specific field. The configuration change data can in this way be limited even further. Another way to separate between different parts of the network is to provide separate configuration indicators and possibly also configuration change indicators for the different parts of the network so that there is one such indicator per device type.

It should furthermore be realised that the invention is not limited to providing the indicators as numerical values that are incremented. As long as a configuration is uniquely identified and the configuration changes are kept track of these indicator can have any suitable form.

The invention can be implemented in any suitable form including hardware, software, firmware or combinations of these. The invention may be implemented as computer software stored in a program memory and run on one or more data processors and/or digital signal processors. The program code can also be provided on a computer program product, of which one is shown in FIG. 7 in the form of an optical disc 60 like CD ROM or DVD. This is just an example and various other types of computer program products are just as well feasible like memory sticks. The computer program product can also be provided in pure program code that can be downloaded for instance from a further server, perhaps via the Internet. The elements and components of an embodiment of the invention may be physically, functionally and logically implemented in any suitable way. Indeed the functionality may be implemented in a single unit, in a plurality of units or may be physically and functionally distributed between different units and processors.

Although the present invention has been described in connection with a specific embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally although individual features may be included in different claims, these may possibly be advantageously combined and the inclusion in different claims does not imply that a combination of features is not feasible and/or advantageous. In addition singular references do not exclude a plurality. Thus references to “a”, “an”, “first”, “second” etc. do not preclude a plurality. Reference signs in the claims are provided merely as a clarifying example and shall not be construed as limiting the scope of the claims in any way.

1. Method of providing information about the configuration of devices (D1, D2, D3) in a network (N) comprising the steps of:
receiving a first query (Q₁) about the configuration of at least a part of the network from a client device (C1), (step 32),
responding (R₁) to the first query with at least partial information about the configuration of said part of the network existing at the time of reception of the first query, (step 34),
receiving a second query (Q₂) about the configuration of said part of the network from said client device (step 36),
determining the difference (CD) in configuration between said part of the network existing at the time of reception of the first query and at the time of reception of the second query, (steps 38, 44), and
responding (R₂) to the second query with information about said difference in configuration, (step 48).

2. Method according to claim 1, further comprising the steps of:
generating a configuration indicator (CI) indicating the configuration of at least a part of the network for each configuration of said part of the network that occurs because of network changes, (steps 14, 24, 28),
storing each configuration indicator together with corresponding configuration information, (steps 16, 30),
wherein the response to the first query comprises a first configuration indicator associated with the configuration existing at the time of reception of the first query, the second query comprises said first configuration indicator and comprising the further steps of:
comparing at least said first configuration indicator with a second configuration indicator associated with the configuration existing at the time of reception of the second query, (step 38),
generating configuration difference data based on the comparison, (steps 42, 46), and
sending said configuration difference data to said device in the response to the second query, (step 48).

3. Method according to claim 2, further comprising the step of setting said configuration difference data as zero if the first and second configuration indicators are equal (step 42).

4. Method according to claim 2, wherein the step of comparing comprises comparing the configurations associated with the first and second configuration indicators (step 44) and further comprising the step of setting the configuration difference data as the difference in configuration between the two configurations (step 46).

5. Method according to claim 2, wherein a configuration indicator is related the whole network.

6. Method according to claim 5, wherein a configuration indicator includes more than one field, where each field is related to a certain part of the network.

7. Method according to claim 2, wherein a configuration indicator is related to a certain part of the network.

8. Method according to claim 2, further comprising the step of:
generating a configuration change indicator for each configuration change that occurs in said part of the network because of network changes,
wherein the response to the first query comprises a first configuration change indicator and the response to the second query comprises a second configuration change indicator.

9. Server (S) for providing information about the configuration of devices (D1, D2, D3) in a network (N) and arranged to:
receive a first query (Q₁) about the configuration of at least a part of the network from a client device (C1),
respond (R₁) to the first query with at least partial information about the configuration of said part of the network existing at the time of reception of the first query,
receive a second query (Q₂) about the configuration of said part of the network from said client device,
determine the difference (CD) in configuration between said part of the network existing at the time of reception of the first query and at the time of reception of the second query, and
respond (R₂) to the second query with information about said difference in configuration.

10. Computer program product (60) for providing information about the configuration of devices (D1, D2, D3) in a network (N), comprising computer program code, to make a computer execute, when said program code is loaded in the computer:
receive a first query (Q₁) about the configuration of at least a part of the network from a client device (C1),
respond (R₁) to the first query with at least partial information about the configuration of said part of the network existing at the time of reception of the first query,
receive a second query (Q₂) about the configuration of said part of the network from said client device,
determine the difference (CD) in configuration between said part of the network existing at the time of reception of the first query and at the time of reception of the second query, and
respond (R₂) to the second query with information about said difference in configuration.

11. Method of receiving information about the configuration of devices (D1, D2, D3) in a network (N), comprising the steps of:
sending a first query (Q₁) about the configuration of at least a part of the network to a server (S), (step 50),
receiving a response (R₁) to the first query with at least partial information about the configuration of said part of the network existing at the time the server received the first query, (step 52),
sending a second query (Q₂) about the configuration of said part of the network to said server, (step 54), and
receiving a response (R₂) to the second query with information about the difference (CD) in configuration between said part of the network existing at the time the server received the first query and at the time the server received the second query, (step 56).

12. Method according to claim 11, wherein
the second query and the response to the first query both comprise a first configuration indicator (CI) associated with the configuration of said part of the network existing at the time the server received the first query, and
the response to the second query comprises configuration difference data that has been generated based on a comparison of at least said first configuration indicator and a second configuration indicator associated with the configuration of said part of the network existing at the time the server received the second query.

13. Method according to claim 12, wherein the response to the first query comprises a first configuration change indicator (CCI) associated with the first configuration indicator and the response to the second query comprises a second configuration change indicator associated with the second configuration indicator.

14. Method according to claim 13, further comprising the step of determining if further network information is needed or not based on the configuration difference response and the first and second configuration change indicators.

15. Method according to claim 11, further comprising the step of updating earlier received configuration information with information about the difference in configuration received in the response to the second query, (step 58).

16. Client device (CI) for receiving information about the configuration of devices (D1, D2, D3) in a network (N) and arranged to:
send a first query (Q₁) about the configuration of at least a part of the network to a server (S),
receive a response (R₁) to the first query with at least partial information about the configuration of said part of the network existing at the time the server received the first query,
send a second query (Q₂) about the configuration of said part of the network to said server, and
receive a response (R₂) to the second query with information about the difference (CD) in configuration between said part of the network existing at the time the server received the first query and at the time the server received the second query.

17. Computer program product (60) for receiving information about the configuration of devices (D1, D2, D3) in a network (N), comprising computer program code, to make a computer execute, when said program code is loaded in the computer:
send a first query (Q₁) about the configuration of at least a part of the network to a server (S),
receive a response (R₁) to the first query with at least partial information about the configuration of said part of the network existing at the time the server received the first query,
send a second query (Q₂) about the configuration of said part of the network to said server, and
receive a response (R₂) to the second query with information about the difference (CD) in configuration between said part of the network existing at the time the server received the first query and at the time the server received the second query.

18. Network (N) of computing devices (S, D1, D2, D3) comprising:
a server (S) for providing information about the configuration of devices (D1, D2, D3) in the network and arranged to:
receive a first query (Q₁) about the configuration of at least a part of the network from a client device (C1),
respond (R₁) to the first query with at least partial information about the configuration of said part of the network existing at the time of reception of the first query,
receive a second query (Q₂) about the configuration of said part of the network from said client device,
determine the difference (CD) in configuration between said part of the network existing at the time of reception of the first query and at the time of reception of the second query, and
respond (R₂) to the second query with information about said difference in configuration, and
a client device (C1) for receiving information about the configuration of devices in the network and arranged to:
send said first query,
receive said response to the first query,
send said second query, and
receive said response to the second query.

19. Signal (R₂) for providing information about the configuration of devices (D1, D2, D3) in a network (N) and comprising information about the difference (CD) in configuration between at least a part of the network existing at the time a server (S) received a first query (Q₁) and at the time said server received a second query (Q₂), where the signal is a response to said second query.
